(19) United States
(12) Patent Application Publication
(10) Pub. No.: US 2026/0340587 A1
(43) Pub. Date: Oct. 29, 2026

(54) PROJECT BUILD MONITORING AND EVALUATING TECHNIQUES

(71) Applicant: AUTODESK, INC., San Francisco, CA (US)

(72) Inventor: Timothy BURNHAM, New Boston, NH (US)

(21) Appl. No.: 19/178,719

(22) Filed: Apr. 14, 2025

(51) Int. Cl. G06Q 10/10; G06F 30/12; G06F 111/02; G06Q 10/0631

(52) U.S. Cl. CPC G06Q 10/103; G06F 30/12; G06Q 10/063114; G06F 2111/02

(57) ABSTRACT

One embodiment sets forth a technique for monitoring and identifying disruptive actions in a project build. According to some embodiments, the technique includes the steps of monitoring one or more actions performed by a first participant of the project build; detecting, based on the monitoring, a disruptive action performed by the first participant that is a trigger for the anomaly in the project build; generating an electronic tag that provides information comprising an identity of the first participant and a time of occurrence of the disruptive action; and evaluating the electronic tag to one of preempt an adverse impact of the anomaly or to rectify an adverse impact of the anomaly.

### BACKGROUND

### Field of the Various Embodiments

Embodiments of the present disclosure relate generally to project build operations, and, more specifically, to techniques for monitoring and evaluating project build operations.

### Description of the Related Art

Effectively managing a project can be an intensive endeavor, particularly for managers who lack the technical expertise to understand various computer-based tools used by people such as engineers and technicians when implementing a project. The complexity of management can increase when the engineers and technicians have diverse backgrounds, diverse technical skills, and diverse levels of work experience. In some cases, such factors can lead to various types of technical issues that require considerable resources to address.

An illustrative example pertains to a team of engineers based in various countries cooperating with each other to build a satellite vehicle. In a hypothetical scenario, a team of engineers based in the United States cooperates with a team of European engineers in assembling the satellite vehicle. Some parts do not fit properly, but in the rush to meet a launch deadline, the parts are assembled without proper review and oversight. The satellite vehicle malfunctions after launch. A subsequent inquiry by a team of analysts reveals that some of the parts that did not fit properly were manufactured in accordance with European metric standards and some others were manufactured in accordance with US customary standards. The inquiry further identifies various types of shortcomings associated with project management, particularly in terms of technical oversight.

In hindsight, one operational structure that could have been implemented in order to forestall the mishap would involve a project management structure having one or more managerial teams to manage the two teams. The project management structure would logically involve multiple people because it would be difficult to identify a single individual who not only has the management skills to oversee the two teams concurrently (logistics, cultural differences, time zone differences, etc.), but also the technical skills necessary to understand details about the tasks being performed by the engineers.

Consequently, implementing the project management structure can involve identifying a first team of managers tasked with quality control oversight of the actions performed by the team of US engineers and a second team of managers tasked with quality control oversight of the actions performed by the team of European engineers. However, such a multi-person structure can not only suffer from various disadvantages (expense, hiring, logistics, payroll, etc.), but may also not preclude the possibility of identifying and eliminating the issue caused by the use of the metric system by the European engineers and the US customary standards by the US engineers.

Another illustrative example pertains to a team of architects, a team of engineers, and a team of laborers, working together to construct a skyscraper. Based on a building schedule the team of architects completes the architectural design and hands over responsibility to the team of engineers. The engineers diligently adhere to the architectural design and supervise the construction of the skyscraper by the team of laborers. The skyscraper is completed per schedule. However, after a period of time, some issues—such as cracking, warping, compression, buckling, and shear—are discovered. A team of material specialists are consulted to resolve the issues. The material specialists identify shortcomings related to decisions such as support structures that may have been designed by the architects with aesthetics in mind and lack of knowledge about consequential structural shortcomings. The results of the study conducted by the material specialists further reveals various costly shortcomings associated with project management, particularly with a lack of multi-disciplinary technical knowledge, a lack of multi-disciplinary cooperation, and a lack of pre-emptive identification of potential problems. Here, again, however, a manual oversight structure using one or more people can suffer from various disadvantages. For example, one or more supervisors may lack the foresight and/or technical expertise to recognize various types of inter-disciplinary problems such as, for example, a shortcoming in a material used to implement an architectural feature specified by an architect (a steel beam versus a rebar, for example).

As the foregoing illustrates, what is needed in the art is an alternative to traditional project management, particularly when collaborative actions are involved.

### SUMMARY

One embodiment sets forth a computer-implemented method to monitor and identify disruptive actions in a project build. According to some embodiments, the method includes the steps of monitoring one or more actions performed by a first participant of the project build; detecting, based on the monitoring, a disruptive action performed by the first participant that is a trigger for an anomaly in the project build; generating an electronic tag that provides information comprising an identity of the first participant and a time of occurrence of the disruptive action; and evaluating the electronic tag to preempt an adverse impact of the anomaly or to rectify the adverse impact of the anomaly.

Other embodiments of the present disclosure include, without limitation, one or more computer-readable media including instructions for performing one or more aspects of the disclosed techniques as well as a computing device for performing one or more aspects of the disclosed techniques.

One technical advantage of the disclosed techniques over the prior art is that the disclosed techniques provide an automated project monitoring system and method that automatically identifies in real time various types of potential issues that may occur in a project build and enables identifying one or more actions that may cause an anomaly. More particularly, a computer-implemented method can monitor actions performed by a first participant of a project build. The monitoring can lead to automatically detecting a disruptive action that can cause the anomaly. The project monitoring system generates an electronic tag that provides information, such as an identity of the first participant and a time of occurrence of the disruptive action. The electronic tag can be subsequently evaluated for various purposes—for example, identifying the first participant—to preempt the anomaly, and/or to take measures to prevent a future repetition of the disruptive action.

Various embodiments of the project monitoring system can be installed on computers of members of a given project build and offer various advantages over prior art manual project management structures. For example, the project monitoring system can be configured by various experts in diverse fields and can be used by multiple users without the need for manual supervision of the users during a project build.

These technical advantages provide one or more technological advancements over prior art approaches.

### BRIEF DESCRIPTION OF THE DRAWINGS

So that the manner in which the above recited features of the various embodiments can be understood in detail, a more particular description of the inventive concepts, briefly summarized above, may be had by reference to various embodiments, some of which are illustrated in the appended drawings. It is to be noted, however, that the appended drawings illustrate only typical embodiments of the inventive concepts and are therefore not to be considered limiting of scope in any way, and that there are other equally effective embodiments.

FIG. 1 illustrates an example system that monitors and identifies actions performed by multiple participants of a project build in accordance with various embodiments.

FIG. 2 is a conceptual illustration of a computer configured to operate as a project monitoring system, according to some embodiments.

FIG. 3 illustrates an example operational aspect associated with a participant of the system shown in FIG. 1, according to some embodiments.

FIG. 4 illustrates a method for automatically monitoring a project build, according to some embodiments.

FIG. 5 is a more detailed illustration of a computing device that can implement the functionalities of the entities illustrated in FIG. 1, according to various embodiment.

### DETAILED DESCRIPTION

In the following description, numerous specific details are set forth to provide a more thorough understanding of the various embodiments. However, it will be apparent to one skilled in the art that the inventive concepts may be practiced without one or more of these specific details.

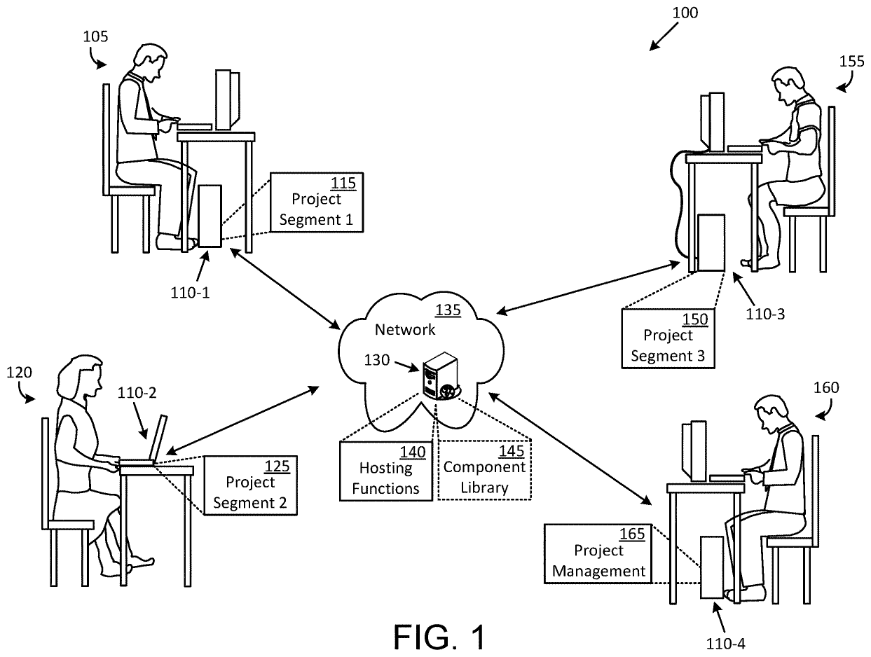

FIG. 1 illustrates an example project monitoring system 100 that monitors and identifies actions performed by multiple participants of a project build in accordance with an embodiment of the disclosure. The project monitoring system 100 is configured to enable a collaborative project build involving multiple participants using various computing platforms that are interconnected via a communications network 135. As shown, the various computing platforms (client devices such as a desktop computing device, a laptop computing device, a mobile computing device, etc.) include a computer 110-1 used by a participant 105, a computer 110-2 used by a participant 120, a computer 110-3 used by a participant 155, and a computer 110-4 used by a participant 160. The project monitoring system 100 further includes one or more cloud computers and/or servers such as a server 130 that is configured to provide various services to the multiple computers used by the various participants of the project build. The communications network 104 can represent, for example, any technically feasible network or number of networks, including a wide area network (WAN) such as the Internet, a local area network (LAN), a Wi-Fi network, a cellular network, or a combination thereof.

In an example embodiment, each of the computers 110 is configured to include a project monitoring system in accordance with the disclosure. More particularly, the computer 110-1 includes hardware and software configured to operate as a first project monitoring system for monitoring actions performed by the participant 105 upon the computer 110-1 for generating a first project segment 115. The computer 110-2 includes hardware and software configured to operate as a second project monitoring system for monitoring actions performed by the participant 120 upon the computer 110-2 for generating a second project segment 125. The computer 110-3 includes hardware and software configured to operate as a third project monitoring system for monitoring actions performed by the participant 155 upon the computer 110-3 for generating a third project segment 150. The project monitoring system 100 can include several more, or fewer, computers having hardware and software configured to operate as project monitoring systems for monitoring actions performed by a group of participants. In the illustrated embodiment, the computer 110-4 includes hardware and software configured to operate as a fourth project monitoring system that may be used by the participant 160 for performing functions that include project management 165 of the other participants of the project build (participant 105, participant 120, and participant 155, in the illustrated example). In another embodiment, the computer 110-4 is omitted and various operations, including project management operations, are performed, either individually or cooperatively, by all the participants of the project build.

In the illustrated example, the server 130 is configured to perform hosting functions 140 and may be further configured to house a component library 145. In an alternative implementation, the component library 145 may be omitted and some or all of the client computers may be configured to house various types of component libraries. Hosting functions 140 can include, for example, providing various tools for generating the various project segments, storing materials associated with various project segments (files, data, information, metadata, backup, etc.), and cloud computing functions. The server 130 may also be configured in some implementations for use by a manager such as the participant 160, for example, to perform federation operations.

The component library 145 can include various types of information pertaining to components that are useable by participants for a project build. In an example implementation, where one or more participants use a computer-aided design (CAD) package, the component library 145 is configured to store various CAD components such as, for example, symbols, icons, and models. Some of the CAD components can conform to various industry-standards such as symbols representing electrical, mechanical, and electronic components (integrated circuits, discrete components, transformers, motors, network symbols, etc.). Some other CAD components can conform to customer standards. One example of a customer standard is a CAD symbol representing an object that is uniquely associated with the customer such as, for example, a brand logo, a trademark, or a pictorial representation of a product.

An example project build is directed to an architectural project such as, for example, designing and constructing a multi-story building. In this context, the participant 105 may use a first computer-aided design (CAD) package to generate an architectural drawing of the building, the participant 155 may use a second CAD package to draft a blueprint of each floor of the building, and the participant 120 may use a third CAD package to generate artwork of the building for posting on a sales website. The participant 160 uses the computer 110-4 for project management 165, which may include performing of federation operations upon various project segments created by the various participants. The federation operations can include performing a clash analysis for identifying anomalies in the project build. The clash analysis includes evaluation of one or more electronic tags generated in accordance with the disclosure. An example anomaly may be caused by the participant 105 generating project segment 115, which in this example, is an architectural drawing containing five rooms on a first floor of the building, and the participant 155 generating project segment 150, which in this example, is a blueprint that erroneously indicates four rooms on the first floor. Another example anomaly may be caused by the participant 120 operating upon project segment 125, which includes modifying a portion of an architectural drawing generated by the participant 105 without obtaining approval of the participant 105. Another example anomaly may be caused by the participant 120 inserting a non-standard object into a blueprint created by the participant 155, or modifying a standard object present in a blueprint created by the participant 155. Another example anomaly may be caused by the participant 105 using a first virtual object that conflicts with a second virtual object used by the participant 155 (an overlap between symbols, for example).

Another example project build is directed to a system, device, or apparatus, such as, for example, a telecommunication product containing printed circuits boards (PCBs) on which are mounted various electronic components. In this example, the participant 105 may use a drawing CAD package to generate project segment 115, which, in this case, is a circuit diagram of an electronic circuit. The circuit diagram may be typically generated by using virtual objects in the form of standard CAD elements (symbols, icons, logos, etc.), primitive building blocks (digital logic gates, component symbols, electrical symbols, mechanical symbols, graphical representations of objects, etc.) obtained from the component library 145. The use of the standard CAD elements ensures interworking compatibility with other participants of the project. However, in an example scenario, the participant 105 may decide to perform a disruptive action by modifying a standard CAD element (a CAD symbol, for example) without the approval or knowledge of one or more other participants of the project. The modification may be carried out for various reasons such as due to lack of work experience, lack of training, or lack of a suitable element representing an object. In an example scenario, the project monitoring system in the computer 110-1 provides a warning to the participant 105 (via a user interface of the computer 110-1) that the disruptive action can cause an anomaly in the project build. Furthermore, the project monitoring system generates an electronic tag that includes information comprising an identity of the participant 105 and a time stamp that provides an indication of the time of modification of the standard CAD element by the participant 105. In an example scenario, the participant 105 decides to ignore the warning and submits the circuit diagram for use by other participants of the project build.

The participant 120 obtains the circuit diagram generated by the participant 105 (via the server 130, for example) and uses a layout CAD package to generate project segment 125, which is this case, is a PCB layout. As described above, the circuit diagram includes a non-standard CAD element. The non-standard CAD element has no equivalent element in the layout CAD package that would be compatible for generating the PCB layout. The project monitoring system in the computer 110-2 provides a warning to the participant 120 (via a user interface of the computer 110-2) that the use of the non-standard CAD element could cause an anomaly and result in a defective project build. Furthermore, the project monitoring system in the computer 110-2 and/or in the computer 110-4 of the participant 160 (who may perform a managerial function) can evaluate the electronic tag that was generated by the project monitoring system in the computer 110-1 upon detection of the modification of the standard CAD element. Evaluation of the electronic tag identifies the participant 105 as the trigger for the anomaly and further identifies the time at which the non-standard CAD element was created.

Various actions can be taken based on the information obtained from the electronic tag. In an example scenario, the project build can be halted and steps taken to either replace the non-standard CAD element with a standard element or to classify the non-standard CAD element as a standard CAD element for future use. Remedial action may also be taken with respect to the participant 105, including establishment of operational measures to prevent a recurrence of the anomaly. Such actions can be carried out as a part of a project efficiency improvement effort.

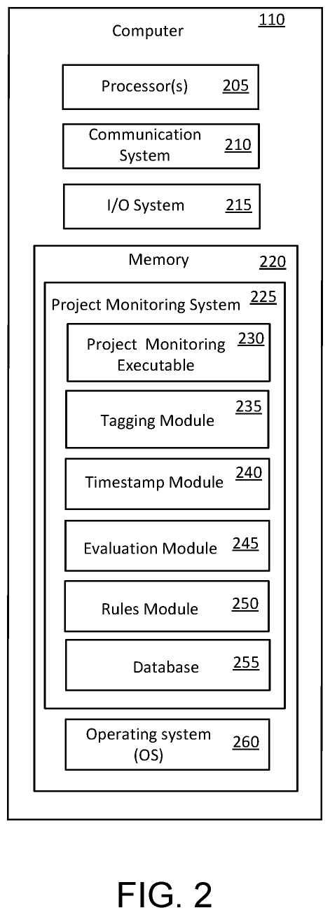

FIG. 2 is a conceptual illustration of a computer 110 configured to operate as a project monitoring system in accordance with the disclosure. The computer 110 represents any of the computer 110-1, the computer 110-2, the computer 110-3, and the computer 110-4 shown in FIG. 1. Computer 110 includes, without limitation, a processor 205, a communication system 210, an input/output (I/O) system 215, and a memory 220.

The processor 205 can include one or more central processing units (CPUs), digital signal processing units (DSPs), microprocessors, application-specific integrated circuits (ASICs), neural processing units (NPUs), graphics processing units (GPUs), field-programmable gate arrays (FPGAs), and so forth. The processor 205 generally includes a programmable processor that executes program instructions to perform operations in accordance with the disclosure. In some embodiments, the processor 205 can include any number of processing cores, and other modules for facilitating program execution.

The communication system 210 includes hardware components that enable the computer 110 to communicate via the communications network 135, with various devices such as those shown in FIG. 1. The hardware components can include for example, wired and/or wireless transmitters, receivers, transceivers configured to provide communications using any of one or more of various communication formats.

The I/O system 215 includes hardware components that enable the computer 110 receive inputs via various types of input devices (keyboard, mouse, modem, etc.) and to provide output via output devices such as a user interface (UI). An example UI includes a display screen on which can be displayed various messages and warnings, such as a warning to a project participant that a modification of a virtual object by the project participant can cause an anomaly in a project build.

The memory 220 includes a memory module or collection of memory modules. The memory 220 generally comprises storage chips such as, for example, random-access memory (RAM) chips that store application programs and data for processing by the processor 205. In various embodiments, the memory 220 includes non-volatile memory such as optical drives, magnetic drives, flash drives, or other storage. A project monitoring system can be stored in the memory 220 in the form of a software application (project monitoring executable 230) that can be executed by the processor 205 to implement various operations in accordance with various embodiments of the disclosure. Such operations include monitoring actions performed by one or more participants of a project build and identifying disruptive actions that can cause anomalies in the project build.

According to an example embodiment, the project monitoring executable 230 is executed by the processor 205 for performing operations that can include monitoring actions performed by a participant of a project build and generating an electronic tag upon detecting a disruptive action such as a modification of a virtual object that can cause an anomaly in the project build. The electronic tag provides information such as an identity of the participant and a time of modification of the virtual object by the participant. A warning is displayed to alert the participant that his/her action can cause an anomaly in the project build.

Execution of the project monitoring executable 230 can include executing the tagging module 235 to generate the electronic tag, executing the timestamp module 240 to include a timestamp in the electronic tag that indicates a time of occurrence of a disruptive action, and executing the evaluation module 245 to evaluate actions performed by the participant for determining whether the actions can cause an anomaly in the project build. In one embodiment, the determination whether an action is a disruptive action that can cause an anomaly in the project build can be made by use of the rules module 250. An example rule included in the rules module 250 specifies that symbols contained in the component library 145 (shown in FIG. 1) cannot be modified. Another rule specifies that the dimensions of a virtual object cannot be modified. Another rule specifies that no portion of a first virtual object can overlap any portion of a second virtual object.

In an embodiment, one or more modules of the project monitoring system such as, for example, the project monitoring executable 230 and/or the evaluation module 245 can include an artificial intelligence/machine language (AI/ML) engine. The AI/ML engine can be based on a generative Al model, a regenerative Al model, a deep learning model, and/or a linear regression block. In an example implementation, the AI/ML engine incorporates various types of algorithms and techniques that replicate human intelligence. In another example implementation, the AI/ML engine performs machine language operations based on information provided in the form of training data. The training data may be generated by historic operations performed by the processor 205 and other such processors. In another example implementation, the AI/ML engine performs AI/ML operations that include a combination of Al operations and ML operations.

The database 255 is configured to hold various types of data including data associated with hosting functions 140 (shown in FIG. 1). Operating system (OS) 260 is selected in accordance with the computing platform on which the project monitoring system is operated.

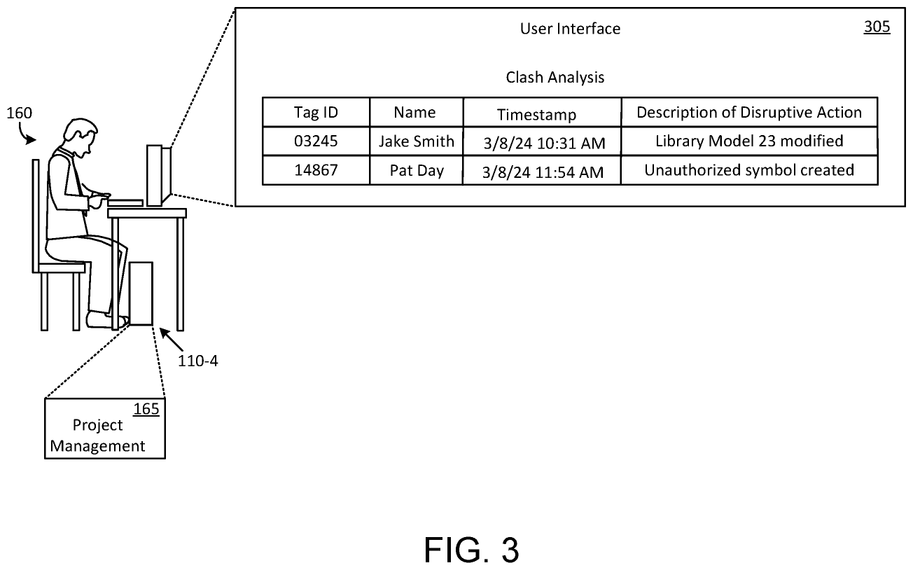

FIG. 3 illustrates an operational aspect associated with the participant 160 shown in FIG. 1. In the illustrated example, participant 160 uses the computer 110-4 for project management 165, which may include performing of federation operations upon various project segments created by the various participants. The federation operations can include performing a clash analysis for identifying anomalies during the project build. The clash analysis includes evaluation of one or more electronic tags generated in accordance with the disclosure upon detection of an anomalous event. An example result of a clash analysis is displayed upon a display screen 305 of the computer 110-4. In the illustrated example, the clash analysis display includes tag IDs of two electronic tags, along with information such as a name, a timestamp, and a description of a disruptive action. In other cases, information pertaining to less than, or more than two electronic tags may be displayed. In another implementation, electronic tag information for each action performed by one or more of the participants is displayed in real time, along with highlighting of one or more disruptive actions (flashing red symbols, bolded text, etc.). A warning can be issued, via a UI, to an offending participant so as to enable the participant to undo an action that triggered the warning.

Based on evaluation of the clash analysis, the participant 160 may initiate actions such as notifying the offending participants, preempt an adverse impact of the anomaly, rectify an adverse impact of the anomaly, establishing measures to prevent a recurrence of the anomaly, and reconfiguring one or more computers of the project monitoring system 100.

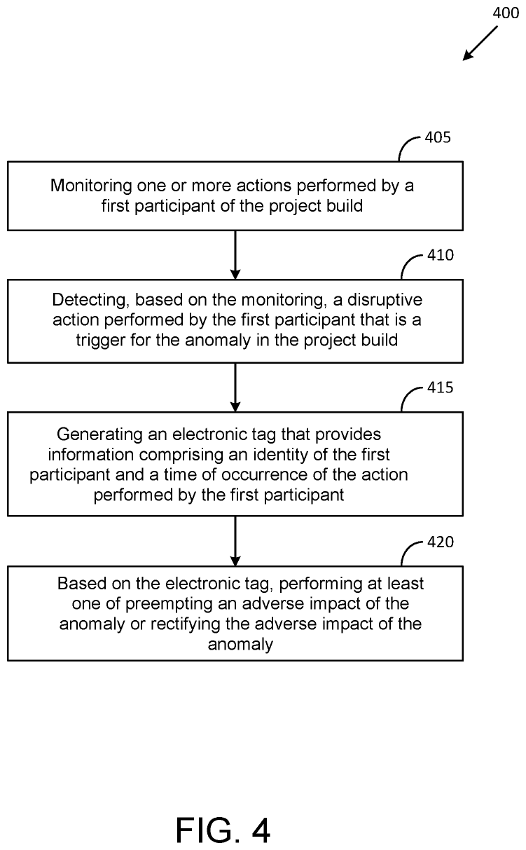

FIG. 4 illustrates a method 400 to monitor and identify an action associated with an anomaly in a project build. At step 405, a computing device such as computer 110 described above monitors one or more actions performed by a first participant of the project build. An example project build is directed to a project that is designed by use of one or more computer-aided design (CAD) packages, such as, for example, a CAD package used to generate a schematic of a machine part, a circuit diagram of an electronic circuit, an icon of a component, a layout of a printed circuit board, a schematic of a building, an engineering drawing of a structure, an engineering drawing of a mechanical assembly, and/or to edit an image, or run a simulation.

At step 410, the computer detects an action performed by the first participant that is a trigger for the anomaly in the project build. The action can constitute a disruptive action because of violating one or more rules included in the rules module 250 shown in FIG. 2. As described above with reference to FIG. 1, an example anomaly may be caused by the participant 105 generating an architectural drawing containing five rooms on a first floor of the building and the participant 155 generating a blueprint that erroneously indicates four rooms on the first floor. Another example anomaly may be caused by the participant 120 operating upon project segment 125, which includes modifying a portion of an architectural drawing generated by the participant 105 without obtaining approval of the participant 105. Another example anomaly may be caused by the participant 120 inserting a non-standard object into a blueprint created by the participant 155 or modifying a primitive building block of a CAD package.

At step 415, the computer generates an electronic tag that provides information comprising an identity of the first participant and a time of occurrence of the disruptive action. At step 420, the computer performs, based on the electronic tag, at least one of preempting an adverse impact of the anomaly or rectifying the adverse impact of the anomaly. In an embodiment, performing the at least one of preempting an adverse impact of the anomaly or rectifying the adverse impact of the anomaly is based on the electronic tag comprises performing a clash analysis procedure to analyze actions performed by at least two participants of the project build, as described above with reference to FIG. 3.

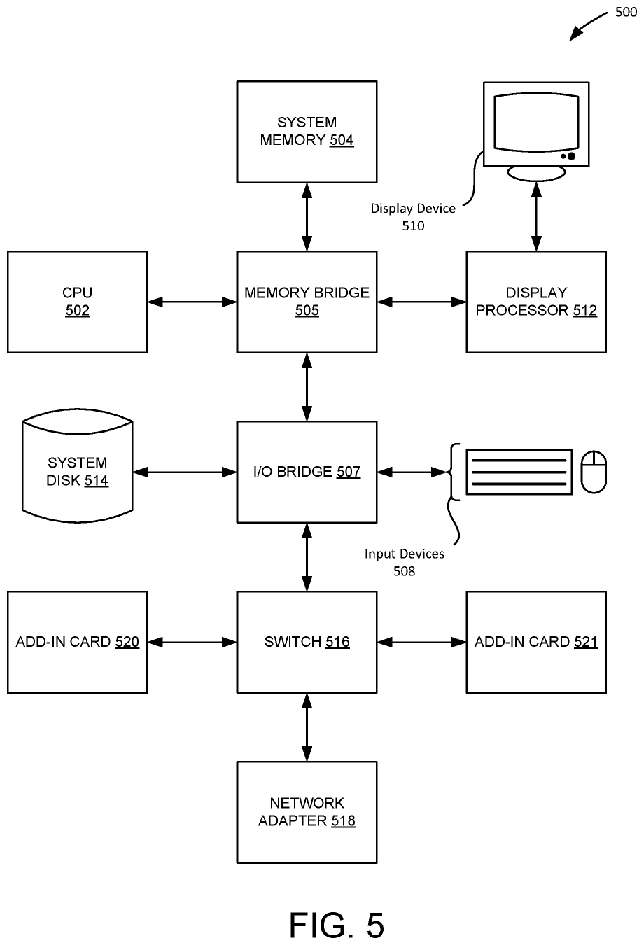

FIG. 5 is a more detailed illustration of a computing device that can implement the functionalities of the entities illustrated in FIG. 1, according to various embodiments. This figure in no way limits or is intended to limit the scope of the various embodiments. In various implementations, system 500 may be an augmented reality, virtual reality, or mixed reality system or device, a personal computer, video game console, personal digital assistant, mobile phone, mobile device or any other device suitable for practicing the various embodiments. Further, in various embodiments, any combination of two or more systems 500 may be coupled together to practice one or more aspects of the various embodiments.

As shown, system 500 includes a central processing unit (CPU) 502 and a system memory 504 communicating via a bus path that may include a memory bridge 505. CPU 502 includes one or more processing cores, and, in operation, CPU 502 is the master processor of system 500, controlling and coordinating operations of other system components. System memory 504 stores software applications and data for use by CPU 502. CPU 502 runs software applications and optionally an operating system. Memory bridge 505, which may be, e.g., a Northbridge chip, is connected via a bus or other communication path (e.g., a HyperTransport link) to an I/O (input/output) bridge 507. I/O bridge 507, which may be, e.g., a Southbridge chip, receives user input from one or more user input devices 508 (e.g., keyboard, mouse, joystick, digitizer tablets, touch pads, touch screens, still or video cameras, motion sensors, and/or microphones) and forwards the input to CPU 502 via memory bridge 505.

A display processor 512 is coupled to memory bridge 505 via a bus or other communication path (e.g., a PCI Express, Accelerated Graphics Port, or Hyper Transport link); in one embodiment display processor 512 is a graphics subsystem that includes at least one graphics processing unit (GPU) and graphics memory. Graphics memory includes a display memory (e.g., a frame buffer) used for storing pixel data for each pixel of an output image. Graphics memory can be integrated in the same device as the GPU, connected as a separate device with the GPU, and/or implemented within system memory 504.

Display processor 512 periodically delivers pixels to a display device 510 (e.g., a screen or conventional CRT, plasma, OLED, SED or LCD based monitor or television). Additionally, display processor 512 may output pixels to film recorders adapted to reproduce computer generated images on photographic film. Display processor 512 can provide display device 510 with an analog or digital signal. In various embodiments, one or more of the various graphical user interfaces such as, for example, the US illustrated in FIG. 3, are displayed to one or more users via display device 510, and the one or more users can input data into and receive visual output from those various graphical user interfaces.

A system disk 514 is also connected to I/O bridge 507 and may be configured to store content and applications and data for use by CPU 502 and display processor 512. System disk 514 provides non-volatile storage for applications and data and may include fixed or removable hard disk drives, flash memory devices, and CD-ROM, DVD-ROM, Blu-ray, HD-DVD, or other magnetic, optical, or solid state storage devices.

A switch 516 provides connections between I/O bridge 507 and other components such as a network adapter 518 and various add-in cards 520 and 521. Network adapter 518 allows system 500 to communicate with other systems via an electronic communications network, and may include wired or wireless communication over local area networks and wide area networks such as the Internet.

Other components (not shown), including USB or other port connections, film recording devices, and the like, may also be connected to I/O bridge 507. For example, an audio processor may be used to generate analog or digital audio output from instructions and/or data provided by CPU 502, system memory 504, or system disk 514. Communication paths interconnecting the various components in FIG. 5 may be implemented using any suitable protocols, such as PCI (Peripheral Component Interconnect), PCI Express (PCI-E), AGP (Accelerated Graphics Port), HyperTransport, or any other bus or point-to-point communication protocol(s), and connections between different devices may use different protocols, as is known in the art.

In one embodiment, display processor 512 incorporates circuitry optimized for graphics and video processing, including, for example, video output circuitry, and constitutes a graphics processing unit (GPU). In another embodiment, display processor 512 incorporates circuitry optimized for general purpose processing. In yet another embodiment, display processor 512 may be integrated with one or more other system elements, such as the memory bridge 505, CPU 502, and I/O bridge 507 to form a system on chip (SoC). In still further embodiments, display processor 512 is omitted and software executed by CPU 502 performs the functions of display processor 512.

Pixel data can be provided to display processor 512 directly from CPU 502. In some embodiments, instructions and/or data representing a scene are provided to a render farm or a set of server computers, each similar to system 500, via network adapter 518 or system disk 514. The render farm generates one or more rendered images of the scene using the provided instructions and/or data. These rendered images may be stored on computer-readable media in a digital format and optionally returned to system 500 for display. Similarly, stereo image pairs processed by display processor 512 may be output to other systems for display, stored in system disk 514, or stored on computer-readable media in a digital format.

Alternatively, CPU 502 provides display processor 512 with data and/or instructions defining the desired output images, from which display processor 512 generates the pixel data of one or more output images, including characterizing and/or adjusting the offset between stereo image pairs. The data and/or instructions defining the desired output images can be stored in system memory 504 or graphics memory within display processor 512. In an embodiment, display processor 512 includes 3D rendering capabilities for generating pixel data for output images from instructions and data defining the geometry, lighting shading, texturing, motion, and/or camera parameters for a scene. Display processor 512 can further include one or more programmable execution units capable of executing shader programs, tone mapping programs, and the like.

Further, in other embodiments, CPU 502 or display processor 512 may be replaced with or supplemented by any technically feasible form of processing device configured process data and execute program code. Such a processing device could be, for example, a central processing unit (CPU), a graphics processing unit (GPU), an application-specific integrated circuit (ASIC), a field-programmable gate array (FPGA), and so forth. In various embodiments any of the operations and/or functions described herein can be performed by CPU 502, display processor 512, or one or more other processing devices or any combination of these different processors.

CPU 502, render farm, and/or display processor 512 can employ any surface or volume rendering technique known in the art to create one or more rendered images from the provided data and instructions, including rasterization, scanline rendering REYES or micropolygon rendering, ray casting, ray tracing, image-based rendering techniques, and/or combinations of these and any other rendering or image processing techniques known in the art.

In other contemplated embodiments, system 500 may be a robot or robotic device and may include CPU 502 and/or other processing units or devices and system memory 504. In such embodiments, system 500 may or may not include other elements shown in FIG. 5. System memory 504 and/or other memory units or devices in system 500 may include instructions that, when executed, cause the robot or robotic device represented by system 500 to perform one or more operations, steps, tasks, or the like.

It will be appreciated that the system shown herein is illustrative and that variations and modifications are possible. The connection topology, including the number and arrangement of bridges, may be modified as desired. For instance, in some embodiments, system memory 504 is connected to CPU 502 directly rather than through a bridge, and other devices communicate with system memory 504 via memory bridge 505 and CPU 502. In other alternative topologies display processor 512 is connected to I/O bridge 507 or directly to CPU 502, rather than to memory bridge 505. In still other embodiments, I/O bridge 507 and memory bridge 505 might be integrated into a single chip. The particular components shown herein are optional; for instance, any number of add-in cards or peripheral devices might be supported. In some embodiments, switch 516 is eliminated, and network adapter 518 and add-in cards 520, 521 connect directly to I/O bridge 507.

In sum, the disclosed techniques set forth a project monitoring system and method that automatically identifies various types of potential issues that may occur in a project build and enables identifying one or more disruptive actions that may have caused, or may cause, an anomaly. For example, an embodiment of the project monitoring system can monitor actions performed by a participant of a project build and detect a disruptive action that causes, or can cause, the anomaly. The project monitoring system then automatically generates an electronic tag that provides information such as an identity of the participant and a time of performance of the action by the participant. The electronic tag can be subsequently evaluated for various purposes. The evaluation may be performed by performing a clash analysis during a federation operation performed as a part of the project build. Some example actions that may be taken based on the results of the clash analysis can include identifying the project participant who performed the action, notifying the project participant, preempting an adverse impact of the anomaly, rectifying an adverse impact of the anomaly, and establishing measures to prevent a recurrence of the anomaly.

One technical advantage of the disclosed techniques over the prior art is that the disclosed techniques provide an automated project monitoring system and method that automatically identifies in real time various types of potential issues that may occur in a project build and enables identifying one or more actions that may cause an anomaly. More particularly, a computer-implemented method can monitor actions performed by a first participant of a project build. The monitoring can lead to automatically detecting a disruptive action that can cause the anomaly. The project monitoring system generates an electronic tag that provides information, such as an identity of the first participant and a time of occurrence of the disruptive action. The electronic tag can be subsequently evaluated for various purposes—for example, identifying the first participant—to preempt the anomaly, and/or to take measures to prevent a future repetition of the disruptive action.
1. In some embodiments, a computer-implemented method to monitor and identify disruptive actions in a project build comprises monitoring one or more actions performed by a first participant of the project build; detecting, based on the monitoring, a disruptive action performed by the first participant that is a trigger for an anomaly in the project build; generating an electronic tag that provides information comprising an identity of the first participant and a time of occurrence of the disruptive action; and based on the electronic tag, performing at least one of preempting an adverse impact of the anomaly or rectifying the adverse impact of the anomaly.
2. The computer-implemented method of clause 1, wherein the disruptive action comprises a modification of a first virtual object that is included in a computer-aided design package.
3. The computer-implemented method of clause 2, wherein detecting that the modification of the first virtual object is the trigger for the anomaly in the project build comprises detecting a conflict between the first virtual object and a second virtual object.
4. The computer-implemented method of clause 1, wherein the disruptive action comprises a modification of a library object that is configured to be used in the project build in an unmodified condition.
5. The computer-implemented method of clause 4, wherein the library object is one of an icon, a symbol, a graphical representation, or an image.
6. The computer-implemented method of clause 1, wherein the disruptive action comprises a modification of a primitive building block of a computer-aided design package.
7. The computer-implemented method of clause 1, further comprising issuing, via a user interface, a warning to the first participant about the disruptive action.
8. The computer-implemented method of clause 1, wherein the disruptive action comprises a modification of a segment of the project build generated by a second participant.
9. The computer-implemented method of clause 1, wherein performing the at least one of preempting an adverse impact of the anomaly or rectifying the adverse impact of the anomaly is based on the electronic tag comprises performing a clash analysis procedure to analyze actions performed by at least two participants of the project build.
10. The computer-implemented method of clause 9, wherein the clash analysis procedure is performed after an occurrence of an adverse event caused by the anomaly in the project build.
11. In some embodiments, one or more non-transitory computer readable media store instructions that, when executed by one or more processors, cause the one or more processors to monitor and identify disruptive actions in a project build, by performing the operations of monitoring one or more actions performed by a first participant of the project build; detecting, based on the monitoring, a disruptive action performed by the first participant that is a trigger for an anomaly in the project build; generating an electronic tag that provides information comprising an identity of the first participant and a time of occurrence of the disruptive action; and based on the electronic tag, performing at least one of preempting an adverse impact of the anomaly or rectifying the adverse impact of the anomaly.
12. The one or more non-transitory computer readable media of clause 11, wherein the disruptive action comprises a modification of a first virtual object that is included in a computer-aided design package
13. The one or more non-transitory computer readable media of clause 12, wherein detecting that the modification of the first virtual object is the trigger for the anomaly in the project build comprises detecting a conflict between the first virtual object and a second virtual object.
14. The one or more non-transitory computer readable media of clause 11, wherein the disruptive action comprises a modification of a library object that is configured to be used in the project build in an unmodified condition.
15. The one or more non-transitory computer readable media of clause 14, wherein the library object is one of an icon, a symbol, a graphical representation, or an image
16. The one or more non-transitory computer readable media of clause 11, wherein the disruptive action comprises a modification of a primitive building block of a computer-aided design package.
17. The one or more non-transitory computer readable media of clause 11, wherein the project build is directed at a project that is generated by use of one or more computer-aided design packages, and wherein monitoring the one or more actions performed by the first participant of the project build comprises monitoring use of one or more virtual objects included in the one or more computer-aided design packages.
18. The one or more non-transitory computer readable media of clause 17, wherein performing the at least one of preempting an adverse impact of the anomaly or rectifying the adverse impact of the anomaly is based on the electronic tag comprises performing a clash analysis procedure to analyze actions performed by at least two participants of the project build.
19. The one or more non-transitory computer readable media of clause 17, wherein evaluating the electronic tag comprises evaluating the electronic tag prior to performing a federation operation of the project build.
20. In some embodiments, a computer system comprises one or more memories that include instructions, and one or more processors that are coupled to the one or more memories and, when executing the instructions, are configured to monitor and identify disruptive actions in a project build, by performing the operations of monitoring one or more actions performed by a first participant of a project build; detecting, based on the monitoring, a disruptive action performed by the first participant that is a trigger for an anomaly in the project build; generating an electronic tag that provides information comprising an identity of the first participant and a time of occurrence of the disruptive action; and based on the electronic tag, performing at least one of preempting an adverse impact of the anomaly or rectifying the adverse impact of the anomaly.

Any and all combinations of any of the claim elements recited in any of the claims and/or any elements described in this application, in any fashion, fall within the contemplated scope of the present disclosure and protection.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments.

Aspects of the present embodiments may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “module,” a “system,” or a “computer.” In addition, any hardware and/or software technique, process, function, component, engine, module, or system described in the present disclosure may be implemented as a circuit or set of circuits. Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine.

The instructions, when executed via the processor of the computer or other programmable data processing apparatus, enable the implementation of the functions/acts specified in the flowchart and/or block diagram block or blocks. Such processors may be, without limitation, general purpose processors, special-purpose processors, application-specific processors, or field-programmable gate arrays.

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The invention has been described above with reference to specific embodiments. Persons of ordinary skill in the art, however, will understand that various modifications and changes may be made thereto without departing from the broader spirit and scope of the invention as set forth in the appended claims. For example, and without limitation, although many of the descriptions herein refer to specific types of I/O devices that may acquire data associated with an object of interest, persons skilled in the art will appreciate that the systems and techniques described herein are applicable to other types of I/O devices. The foregoing description and drawings are, accordingly, to be regarded in an illustrative rather than a restrictive sense.

While the preceding is directed to embodiments of the present disclosure, other and further embodiments of the disclosure may be devised without departing from the basic scope thereof, and the scope thereof is determined by the claims that follow.

What is claimed is:

1. A computer-implemented method to monitor and identify disruptive actions in a project build, the computer-implemented method comprising:
monitoring one or more actions performed by a first participant of the project build;
detecting, based on the monitoring, a disruptive action performed by the first participant that is a trigger for an anomaly in the project build;
generating an electronic tag that provides information comprising an identity of the first participant and a time of occurrence of the disruptive action; and
based on the electronic tag, performing at least one of preempting an adverse impact of the anomaly or rectifying the adverse impact of the anomaly.

2. The computer-implemented method of claim 1, wherein the disruptive action comprises a modification of a first virtual object that is included in a computer-aided design package.

3. The computer-implemented method of claim 2, wherein detecting that the modification of the first virtual object is the trigger for the anomaly in the project build comprises detecting a conflict between the first virtual object and a second virtual object.

4. The computer-implemented method of claim 1, wherein the disruptive action comprises a modification of a library object that is configured to be used in the project build in an unmodified condition.

5. The computer-implemented method of claim 4, wherein the library object is one of an icon, a symbol, a graphical representation, or an image.

6. The computer-implemented method of claim 1, wherein the disruptive action comprises a modification of a primitive building block of a computer-aided design package.

7. The computer-implemented method of claim 1, further comprising issuing, via a user interface, a warning to the first participant about the disruptive action.

8. The computer-implemented method of claim 1, wherein the disruptive action comprises a modification of a segment of the project build generated by a second participant.

9. The computer-implemented method of claim 1, wherein performing the at least one of preempting an adverse impact of the anomaly or rectifying the adverse impact of the anomaly is based on the electronic tag comprises performing a clash analysis procedure to analyze actions performed by at least two participants of the project build.

10. The computer-implemented method of claim 9, wherein the clash analysis procedure is performed after an occurrence of an adverse event caused by the anomaly in the project build.

11. One or more non-transitory computer readable media storing instructions that, when executed by one or more processors, cause the one or more processors to monitor and identify disruptive actions in a project build, by performing the operations of:
monitoring one or more actions performed by a first participant of the project build;
detecting, based on the monitoring, a disruptive action performed by the first participant that is a trigger for an anomaly in the project build;
generating an electronic tag that provides information comprising an identity of the first participant and a time of occurrence of the disruptive action; and
based on the electronic tag, performing at least one of preempting an adverse impact of the anomaly or rectifying the adverse impact of the anomaly.

12. The one or more non-transitory computer readable media of claim 11, wherein the disruptive action comprises a modification of a first virtual object that is included in a computer-aided design package.

13. The one or more non-transitory computer readable media of claim 12, wherein detecting that the modification of the first virtual object is the trigger for the anomaly in the project build comprises detecting a conflict between the first virtual object and a second virtual object.

14. The one or more non-transitory computer readable media of claim 11, wherein the disruptive action comprises a modification of a library object that is configured to be used in the project build in an unmodified condition.

15. The one or more non-transitory computer readable media of claim 14, wherein the library object is one of an icon, a symbol, a graphical representation, or an image.

16. The one or more non-transitory computer readable media of claim 11, wherein the disruptive action comprises a modification of a primitive building block of a computer-aided design package.

17. The one or more non-transitory computer readable media of claim 11, wherein the project build is directed at a project that is generated by use of one or more computer-aided design packages, and wherein monitoring the one or more actions performed by the first participant of the project build comprises monitoring use of one or more virtual objects included in the one or more computer-aided design packages.

18. The one or more non-transitory computer readable media of claim 17, wherein performing the at least one of preempting an adverse impact of the anomaly or rectifying the adverse impact of the anomaly is based on the electronic tag comprises performing a clash analysis procedure to analyze actions performed by at least two participants of the project build.

19. The one or more non-transitory computer readable media of claim 17, wherein evaluating the electronic tag comprises evaluating the electronic tag prior to performing a federation operation of the project build.

20. A computer system, comprising:
one or more memories that include instructions; and
one or more processors that are coupled to the one or more memories and, when executing the instructions, are configured to monitor and identify disruptive actions in a project build, by performing the operations of:
monitoring one or more actions performed by a first participant of a project build;
detecting, based on the monitoring, a disruptive action performed by the first participant that is a trigger for an anomaly in the project build;
generating an electronic tag that provides information comprising an identity of the first participant and a time of occurrence of the disruptive action; and
based on the electronic tag, performing at least one of preempting an adverse impact of the anomaly or rectifying the adverse impact of the anomaly.
